(19) United States
(12) Patent Application Publication
(10) Pub. No.: US 2016/0321631 A1
(43) Pub. Date: Nov. 3, 2016

(54) Method And Device For The Energy Billing Of Mobile Energy Consumers In An Electrical Energy Supply Network

(71) Applicant: SIEMENS AKTIENGESELLSCHAFT, München (DE)

(72) Inventor: OLIVER GRAEBNER, NEUBIBERG (DE)

(21) Appl. No.: 15/105,064

(22) PCT Filed: Dec. 10, 2014
(86) PCT No.: PCT/EP2014/077201

§ 371 Date: Jun. 16, 2016

(30) Foreign Application Priority Data
Dec. 18, 2013 (DE) 10 2013 226 415.1

(51) Int. Cl. G06Q 20/14; B60M 1/12; B60M 1/30; B60L 5/00

(52) U.S. Cl. CPC G06Q 20/145; B60L 5/005; B60M 1/12; B60M 1/30; B60L 2200/36; B61L 25/025

(57) ABSTRACT

A method for the energy billing of mobile energy consumers in an energy supply network with a plurality of network segment operators which are allocated network segments that are territorially separate from one another. The transition of a mobile energy consumer from one network segment to another network segment is detected, and the energy consumed by the mobile energy consumer between two transitions in a network segment is allocated to the network segment. A corresponding device of a mobile energy consumer has an energy-measuring unit that determines the energy consumed by the mobile energy consumer. The device also has a detection unit for detecting a transition of the mobile energy consumer from one network segment to another network segment, and a calculator unit for gathering and storing the data determined by the energy-measuring unit and the detection unit.

The invention relates to a method for the energy billing of mobile energy consumers in a power grid having a plurality of grid section operators to which grid sections that are territorially separate from one another are assigned. The invention also relates to a mobile energy consumer device for energy billing in a power grid having a plurality of grid operators to which grid sections that are territorially separate from one another are assigned, wherein the device has an energy measuring unit which determines the energy consumed by the mobile energy consumer. The invention additionally relates to a data distribution unit. The invention further relates to a mobile energy consumer. The invention lastly relates to a grid section.

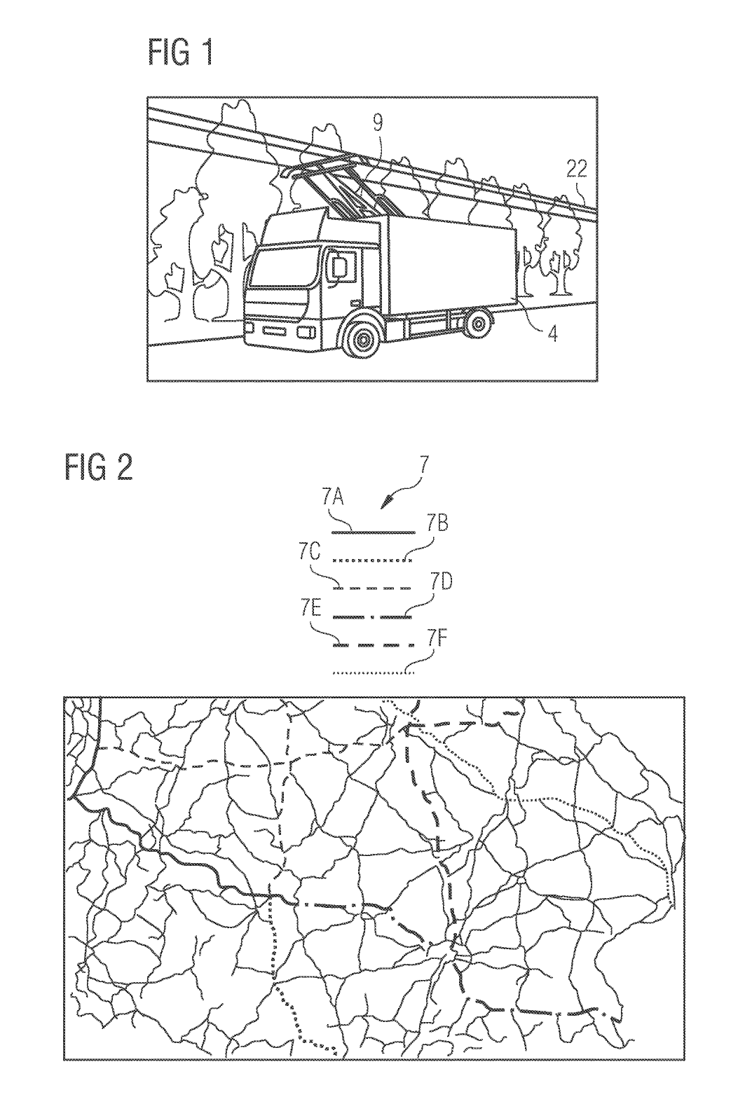

In the liberalized energy market, the problem of energy billing for loads that are nonstationary while they draw energy from the grid often arises. This is a problem, for example, in track-bound (but not track-guided) energy supply systems such as a system comprising electrified roadways or individual electrified traffic lanes. Electrical energy can be supplied using overhead lines with which swivel-mounted current collectors of vehicles, particularly commercial vehicles, so-called pantographs, are brought into contact (see FIG. 1). The energy supplied by the power grid is used, for example, as traction energy for propelling the respective vehicle. Particularly for vehicles of logistics companies, e.g. trucks, an energy-saving and low-cost energy supply is therefore provided.

According to the rules of the liberalized energy market, the operators of electrified vehicles can obtain their electrical traction energy from freely selectable electricity suppliers. The overhead line infrastructure operators have to convey the electrical energy provided by the electricity suppliers through the overhead line infrastructure to the electrified vehicles.

In the liberalized energy market, however, no nonstationary energy tapping points are provided, which results in major difficulties in the case of mobile energy consumers in contact with an energy supply while they are moving. The architecture of the liberalized energy market is based on fixed energy tapping points which constitute the end points of the distribution grid. At these end points, the energy drawn is measured and the measurement is transmitted to the electricity suppliers. The end points can be, for example, charge points or also other stationary power connections of users. The electricity suppliers bill them accordingly for the electrical energy drawn. Part of this electricity price is transferred to the grid operators by the electricity producers as a so-called grid fee. In the case of fixed installation of the energy generation point and energy tapping point, this billing is easily implemented, as the energy supply positions are unchanging and there are therefore no difficulties of any kind in assigning them to a grid operator or rather a grid section operator. For example, electric cars draw the energy for charging the on-board energy storage device from electric charge points. The loads (=electric car) are also mobile, but during the energy drawing process they are stationary and the energy tapping point is here the charge point which is likewise installed in a fixed manner.

On the other hand, a problem arises if, however, the loads also change position during the energy drawing process and the distribution of the grid fee to different infrastructure operators is to be implemented during a continuous, nonstationary energy drawing process, as in this case the assignment of the energy drawn to the individual grid section operators is no longer guaranteed.

Rail traction power supply also poses a similar problem: the individual rail transport companies which own the electrified stock must likewise draw traction energy via an overhead line infrastructure. However, in the case of rail, in contrast to the above described case, there is a single grid operator and energy supplier simultaneously belonging to the same company.

In the liberalized energy market, the processes, roles and data models defined by the Bundesnetzagentur (Federal Network Agency for Electricity, Gas, Telecommunications, Post and Railway) are used. However, these processes are based on the assumption that energy tapping points are installed in a fixed manner.

The object of the present invention is therefore to solve the above mentioned problems by developing a method for the energy billing of mobile energy consumers in a power grid having a plurality of grid section operators, and a device for a mobile energy consumer for energy billing in a power grid having a plurality of grid section operators.

This object is achieved, on the one hand, by a method for the energy billing of mobile energy consumers as claimed in claim 1 and, on the other, by a device for energy billing as claimed in claim 10, by a data distribution unit as claimed in claim 14, by a mobile energy consumer as claimed in claim 15, and by a grid section as claimed in claim 17.

According to the invention, in the case of the method for the energy billing of mobile energy consumers, the crossover of a mobile energy consumer from one grid section to another grid section is detected and the energy consumed by the mobile energy consumer between two crossovers in a grid section is assigned to the grid section.

Detecting when the load crosses over into a new grid section which is operated by another grid section operator, for example, makes it possible, particularly in a track-bound energy supply system, to determine the grid section in which the mobile energy consumer is currently located after the crossover. The energy drawn from the grid by the mobile energy consumer in a grid section is then assigned to the current grid section. Assignment of the energy consumed to the individual grid sections is therefore possible even if the mobile energy consumer frequently changes grid sections. The mobile energy consumer can be, for example, a vehicle having a so-called pantograph which continuously collects energy in a track-bound manner from an overhead line or another track-bound energy supply system, for example. In particular, the mobile energy consumer can be a truck having a current collector, e.g. a pantograph. The liberalized energy grid is subdivided into grid sections which are assigned to different operators or rather grid section operators. The latter demand a grid fee for the use of their respective grid section.

According to the invention, the device has a detection unit for detecting a crossover of the mobile energy consumer from one grid section to another grid section, and a processing unit for acquiring and storing the data determined by the energy measuring unit and by the detection unit.

The detection unit is used to detect data allowing the grid section in which the mobile energy consumer is currently located to be determined. The processing unit advantageously enables data in respect of energy consumption and current grid section to be acquired and stored. In addition, the assignment of said data can also proceed so that, for example, data records with an unambiguous assignment of the energy consumption to the respective grid section can be generated. This data can be communicated to other instances of the power grid where it can also be further processed or forwarded.

In addition, the data distribution unit according to the invention is designed to assign to the associated grid section operator the grid section data transmitted by the device.

The data distribution unit can have, for example, a processing unit which assigns the energy consumption values to an electricity supplier on the basis of the license plate of the mobile energy consumer or meter number of the energy measuring apparatus. In addition, the processing unit can assign the energy consumption values to the grid section operators of the grid sections, in particular of the overhead line sections, e.g. overhead line infrastructure operators, based on detection of the crossover of the mobile energy consumer from one grid section to another (or in particular from one overhead line section to another). The data distribution unit can also generate a billing data record for the identified electricity supplier and transmit the energy consumption values, broken down by associated grid section, to the electricity suppliers. The data distribution unit or processing unit of the data distribution unit can additionally generate an energy consumption data record for the identified grid section operator and send the energy consumption values, broken down by associated grid section, to the grid section operator.

The mobile energy consumer according to the invention has a device according to the invention and/or a transmission unit according to the invention. The transmission unit transmits the data determined in the mobile energy consumer to the data distribution unit according to the invention, for example.

The grid section according to the invention for a power grid has at least one location identifier for marking the boundary between two adjacent grid sections of the power grid, and preferably at least one administration system according to the invention. The location identifier provides a particularly simple means of detecting a crossover of a mobile energy consumer from one grid section to another. The administration system receives the data transmitted from the data distribution unit to the grid section operator and processes and stores it.

The power grid can be in particular a track-bound power grid providing a continuous energy supply, e.g. an overhead line system.

Other particularly advantageous embodiments and further developments of the invention will emerge from the dependent claims and the following description, wherein the independent claims of one claim category can also be further developed analogously to the dependent claims of another claim category.

In a particularly advantageous embodiment of the method, the energy consumed in and assigned to the grid section is assigned to the grid section operator operating the grid section. For this purpose, according to an advantageous embodiment, the device according to the invention is designed to assign the energy consumed in the grid section by the mobile energy consumer to the grid operator operating the grid section.

Thus, the energy consumed in a particular grid section can be billed in favor of the associated grid operator individually and precisely according to the respective consumption, even if the mobile energy consumer frequently changes grid sections.

The above described method can be particularly usefully employed if the power grid is a track-bound and/or electrical supply grid and the mobile energy consumer is an electrified vehicle having a current collector, e.g. a pantograph. Thus the individual loads can be unambiguously assigned to a particular grid section.

Especially in the case of trucks which have a high energy consumption and, being equipped with a conventional internal combustion engine, often have very high emissions and a high energy consumption, the combination of electric propulsion and a power grid which supplies power continuously to the truck throughout its journey or at least over a long distance is particularly effective, as the disadvantages of supplying energy from an on-board electrical energy source, such as weight, space requirement, heat generation and high costs, for example, resulting from the high energy capacity required for a truck's energy storage unit can be avoided.

In order to detect the crossover of the mobile energy consumer from one grid section to another grid section, the position of the mobile energy consumer can be determined by a suitable position determination method using a position determination system, wherein the determined position of the mobile energy consumer is assigned to a grid section. To implement position determination, the detection unit of the device according to the invention has, for example, a positioning unit for determining the position of the mobile ultimate load.

In a particularly advantageous embodiment of the invention, a location identifier is read at the step of detecting the crossover of the mobile energy consumer from one grid section to another grid section. The location identifier indicates the crossover of the mobile energy consumer from one grid section to another grid section. To read the location identifier, the detection unit of the device according to the invention has a reader unit for reading location identifiers.

If the energy supplied to the mobile energy consumer is supplied via an overhead line, it is particularly advantageous if the location identifier is on the overhead line of the power grid, as it is then particularly easy to read the location identifier from the mobile energy consumer, e.g. a motor vehicle, by means of a contactless reading method, for example.

Alternatively or additionally, a global positioning system (e.g. GPS, GLONASS, Galileo, Compass) can also be used for position determination in order to detect the passage of the mobile energy consumer from one grid section to another. It is advisable that position determination of the mobile energy consumer is repeated after a predetermined time interval in order to make the assignment of the energy consumed to the respective grid section as accurate as possible.

In addition to a plurality of grid operators, the situation can also arise that the mobile energy consumers are assigned different individual energy suppliers. The energy suppliers receive a corresponding payment from the mobile users for the energy supplied, but must usually, for their part, pay the respective grid section operator a grid feed or grid section fee depending on the amount of energy supplied. Here it is particularly important to know how much energy from which energy supplier has been consumed by which load in which grid section. The corresponding assignment is made considerably easier and precise, or possible for the first time, by the above described method.

In order to determine the energy consumption of the respective mobile energy consumer, measurement of the energy consumption of the mobile energy consumer is advantageously begun when the mobile energy consumer connects to the power grid and is terminated when the mobile energy consumer disconnects from the power grid.

In order to obtain the correct consumption value, the energy consumption of the mobile energy consumer is determined on the basis of the measured energy drawn from the power grid and the measured energy fed back into the power grid.

Determining of the crossover from one grid section to another can be particularly effectively implemented by the location identifier being read by a reader unit when the mobile energy consumer passes the location identifier. Said reader unit is advantageously mounted on the mobile energy consumer.

In order to enable the energy consumption values to be processed further, they are stored in a processing unit in the device according to the invention after the crossover of the mobile energy consumer from one grid section to another. The energy consumption values can likewise also be stored in said processing unit after the mobile energy consumer disconnects from the power grid.

Even the event of the mobile energy consumer connecting to the power grid itself and the event of the mobile energy consumer disconnecting from the power grid can be stored by the processing unit in order to obtain a comprehensible log of the actions of the respective load or more specifically the time of termination of the energy consumption measurement process.

The assignment of the energy consumption to the respective grid sections or rather to the respective grid section operators is made possible due to the fact that the information determined in connection with the detection of the crossover of the mobile energy consumer from one grid section to another is stored in the processing unit. According to a particularly advantageous embodiment, said processing unit of the device according to the invention is designed to assign the energy consumed by the mobile energy consumer as measured by the energy measuring unit between two crossovers in a grid section to the operator of the grid section.

In order to pass on the collected information to a grid operator or an energy supplier, for example, in a particularly easily process able manner, it is particularly effective if the processing unit is designed to generate a data record which assigns the energy, as measured by the energy measuring unit, that is consumed between two crossovers by the mobile energy consumer in a grid section to the grid section.

In order to arrange the data traffic and organize it in a particularly effective manner in the entire network, it is advisable that the device according to the invention has a transmission unit for transmitting data determined by the device to a data distribution unit. Said data distribution unit is in particular designed to transfer the assigned data to the energy supplier assigned to a respective mobile energy consumer.

In a particularly useful and cost-effective embodiment of the invention, the mobile energy consumer is a truck and has an electric drive and a device for establishing contact with an electrical supply line of an electrical power grid. The contact-establishing device can be a pantograph, for example. In addition to the electric motor, the truck can have, for example, other generator sets such as an internal combustion engine in order to be able to operate on non-electrified routes. In particular, hybrid electrical systems of any kind can be installed.

The invention will now be explained in greater detail with reference to the accompanying drawings on the basis of exemplary embodiments. Identical components are provided with the same reference characters in the different figures:

FIG. 1 shows a truck having an electrical drive and a pantograph for establishing contact with an electrical supply line of a power grid,

FIG. 2 shows a map of power grid for track-bound energy supply of route system, a plurality of grid sections being marked out,

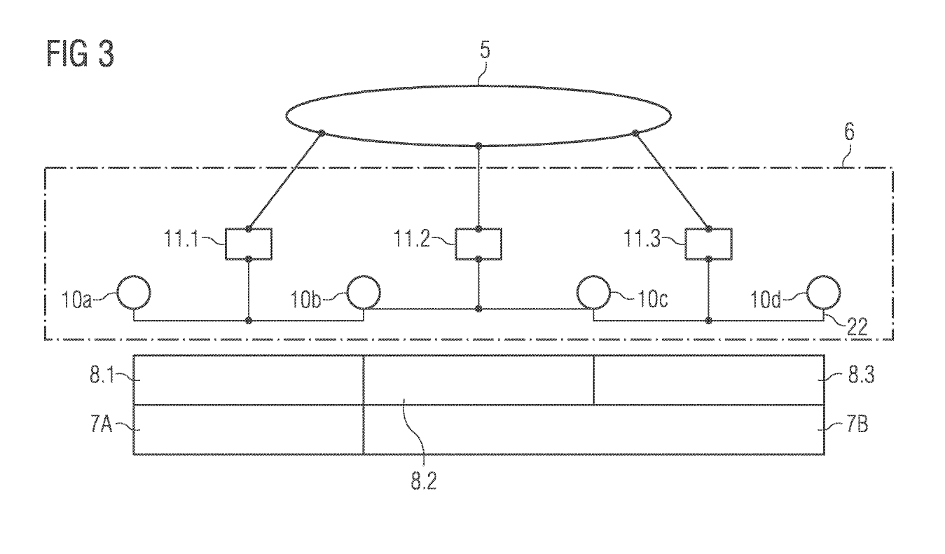

FIG. 3 schematically illustrates the layout of a power grid comprising grid sections according to an embodiment of the invention,

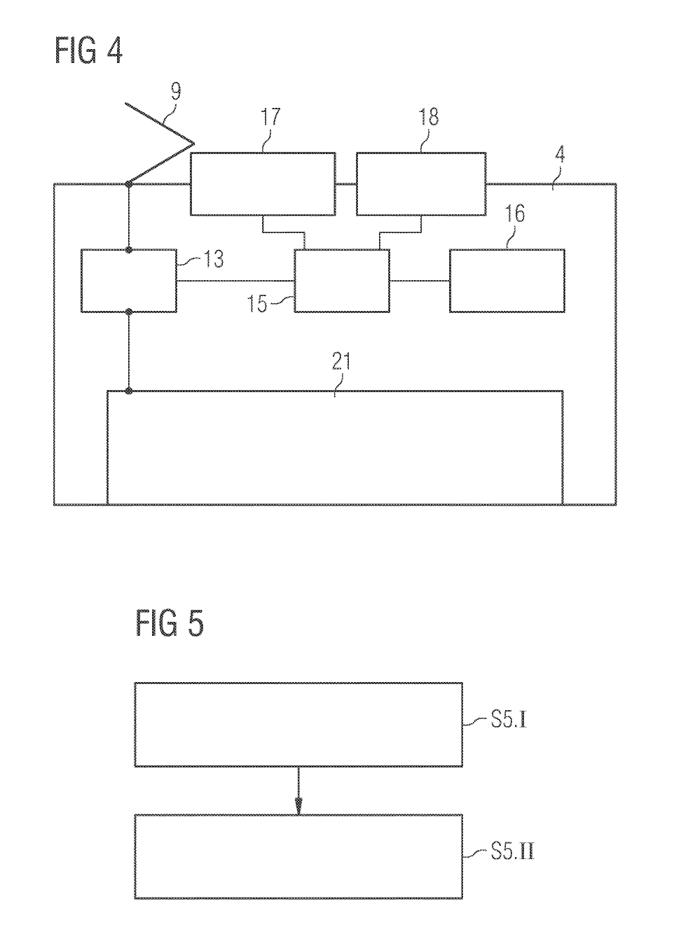

FIG. 4 shows a block diagram of a mobile energy consumer according to an embodiment of the invention,

FIG. 5 shows a flow chart of the method according to a first exemplary embodiment of the invention,

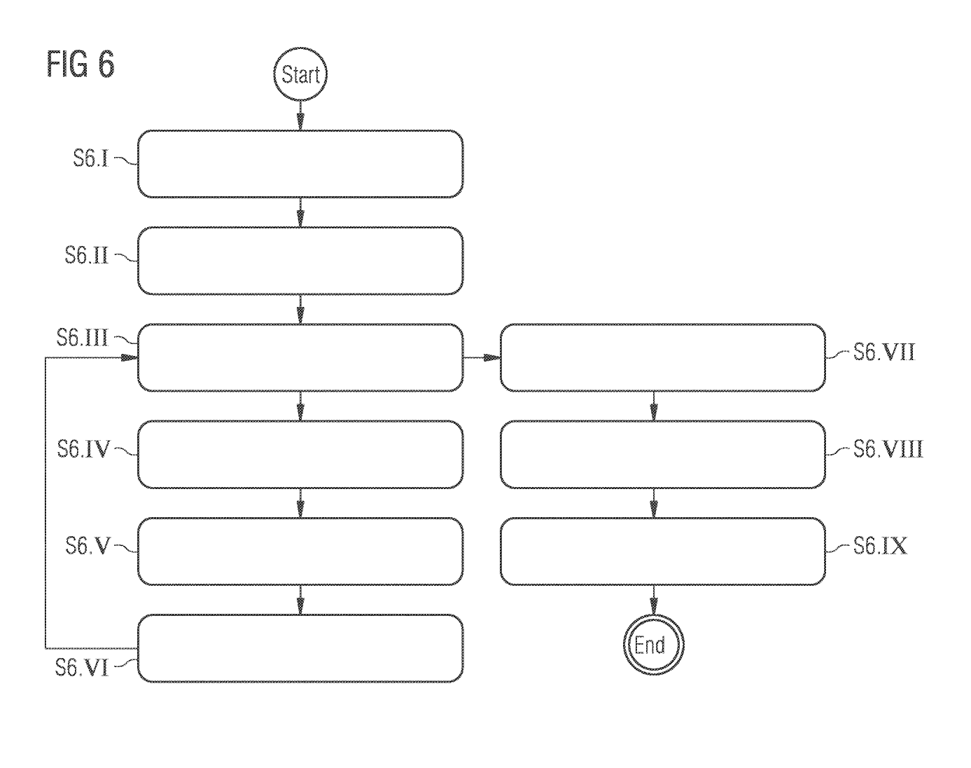

FIG. 6 shows a flow chart of the method according to a second exemplary embodiment of the invention,

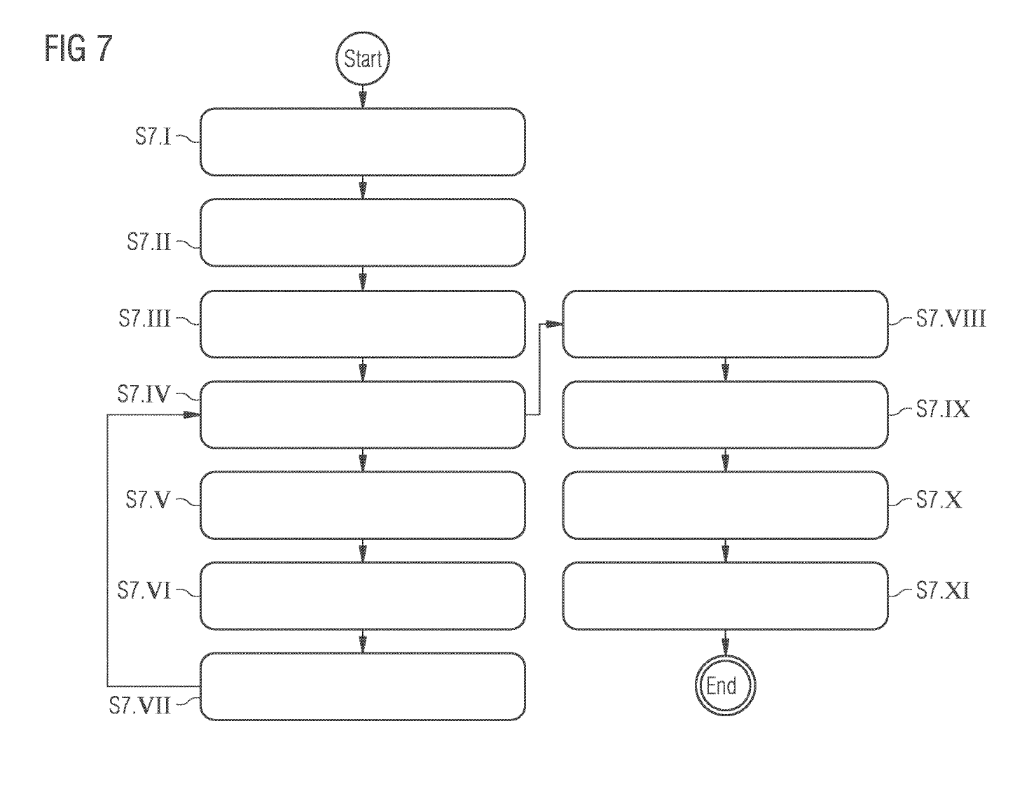

FIG. 7 shows a flow chart of the method according to a third exemplary embodiment of the invention.

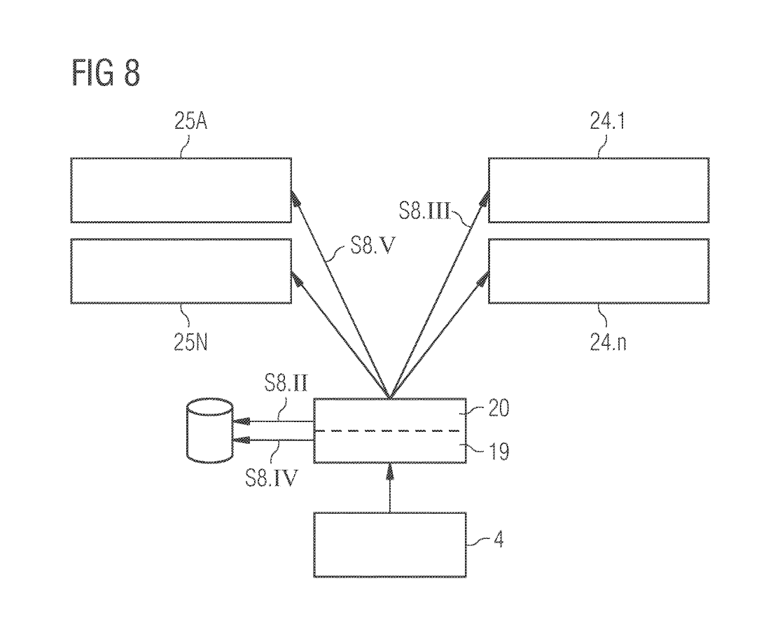

FIG. 8 schematically illustrates data transmission between the mobile energy consumer and the individual units of the power grid according to a first exemplary embodiment of the invention,

FIG. 1 shows a truck 4 having an electric drive and a pantograph 9 for establishing contact with an electrical supply line 22 of a power grid 5. Because of the continuous supply of energy, said truck 4 can manage long distances without a problem using electric drive but nevertheless has the same flexibility as a conventional truck having an internal combustion engine. This is achieved, for example, by having a flexible pantograph 9 so that the vehicle 4 can move transversely to the roadway. If the vehicle 4 wishes to leave the track of the electrical supply line 22, the pantograph 9 can be lowered, i.e. retracted. Overtaking and running on non-electrified sections can be handled, for example, using a small additional electrical energy storage device or a hybrid drive system.

FIG. 2 shows by way of example a map of southern Germany with an overhead line system for track-bound electric vehicles. Only the highways are equipped with overhead lines. The overhead lines are assigned to different overhead line infrastructure operators 7A to 7B (hereinafter also termed grid section operators) in different grid sections indicated by different line markings.

FIG. 3 illustrates a power grid or rather a distribution grid 5 having a plurality of grid sections 8 according to an embodiment of the invention. The overhead line infrastructure operators 7A, 7B shown in FIG. 3 correspond to the overhead line infrastructure operators 7A, 7B shown in FIG. 2. The electrical energy from the distribution grid 5 is converted to the type of electrical energy required by the overhead line 22 (e.g. 650 VDC) via substations 11.1, 11.2 and 11.3 The substations 11.1, 11.2, 11.3 supply the connected overhead line infrastructure sections 8.1, 8.2, and 8.3 respectively which are also termed grid sections. The individual substations 11.1, 11.2, 11.3 with the respective overhead line section/overhead line infrastructure section 8.1, 8.2, 8.3 are assigned to the grid section operators/overhead line infrastructure operators 7A, 7B. More precisely, the overhead line section 8.1 is assigned to the grid section operator 7A and the overhead line sections 8.2 and 8.3 are assigned to the grid section operator 7B. For example, in FIG. 3 the substation 11.1 is assigned to the overhead line infrastructure section 8.1 which is operated by the overhead line infrastructure operator 7A. The substation 11.2 is assigned to an overhead line infrastructure section 8.2 which is operated by another overhead line infrastructure operator 7B. The substation 11.3 is assigned to the overhead line infrastructure section 8.3 which, like the overhead line infrastructure section 8.2, is operated by the overhead line infrastructure operator 7B. To detect a grid section change, location identifiers 10a to 10d which identify the crossover from one overhead line section to another are provided on the overhead line 22. These location identifiers 10 are contactless identifiers which can be read e.g. via radio (e.g. according to sensor networks, RFID tags or UHF-RFID tags) preferably over short distances (e.g. between 1 and 5 m). In FIG. 3, a location identifier 10a is marked at the left-hand edge of the overhead line infrastructure section 8.1. Another location identifier 10b is marked at the boundary between the overhead line infrastructure section 8.1 and the overhead line infrastructure section 8.2 A location identifier 10c is disposed at the boundary between the overhead line infrastructure section 8.2 and the overhead line infrastructure section 8.3, and a location identifier 10d is disposed at the right-hand edge of the overhead line infrastructure section 8.3.

FIG. 4 shows an electric vehicle 4 with track-bound energy supply, more generally also a mobile energy consumer 4. The mobile energy consumer 4 draws electrical traction energy via a current collector, more specifically a pantograph 9, from the power grid 5, in this case an overhead line infrastructure network 6. The electrical energy drawn is measured by an energy measuring unit or energy measuring apparatus 13 and the electric drive 21 thereby provides traction for the vehicle 4. During braking, electrical energy can be fed back into the overhead line 22 via the drive 21 in generator mode, this likewise being measured by the energy measuring apparatus 13. The track-bound electric vehicle 4 has a processing unit 15 which collects and stores the measurements of the energy measuring apparatus 13. In addition, when the vehicle passes the location identifiers 10 of the overhead line infrastructure 6, the data from the location identifiers 10 is read by a reader unit 17 and the data is likewise acquired and stored by the processing unit 15. The electrical measured values and the data of the location identifiers 10 are transmitted at particular intervals by means of a transmission unit 18 to the processing unit 20 in the data distribution unit 19 for data distribution (shown in FIG. 8). According to an alternative embodiment, the overhead line infrastructure 6 can also manage without location identifiers 10 if location detection takes place cyclically on the electrified vehicle 4 via a positioning unit 16 (e.g. equipped with GPS, GLOONASS, Galileo or Compass). This location data is likewise buffered by the processing unit 15 together with the electrical measurements, i.e. the energy consumption values. Alternatively, a combination of both systems can also be used.

FIG. 5 shows a flow chart according to a first embodiment of the invention. In step S5.I, the crossover of a mobile energy consumer 4 from one grid section 8 to another grid section 8 is detected. In step S5.II, the energy consumed by the mobile energy consumer 4 between two crossovers in a grid section 8 is assigned to the grid section 8. This makes it possible to bill the energy consumed by a mobile energy consumer 4, broken down by grid sections 8 in which the energy has been respectively consumed.

The flow chart in FIG. 6 describes the individual steps of an exemplary embodiment of the method according to the invention. In particular, the process steps of measuring and storing the different data e.g. on the track-bound electrified vehicle 4 in FIG. 4 are shown here. First the process is started. In step S6.I the electrified vehicle 4 raises its pantograph 9 and makes contact with overhead line 22. In step S6.II the pantograph-up event is stored by the processing unit 15. In step S6.III the energy drawn or fed back by the electrified vehicle 4 during movement or operation of the electrified vehicle 4 is stored. In step S6.IV the vehicle 4 passes near a location identifier 10 and the reader unit 17 reads the location identifier 10. From this it can be inferred that the vehicle 4 is just leaving a grid section 8. Measurement of the energy consumption assigned to the grid section 8 just left is therefore terminated. For this reason the processing unit 15, in step S6.V, stores the determined energy consumption values for the grid section 8 just left. In addition, in step S5.VI the data of the location identifier 10 is also stored by the processing unit 15. The energy consumption measurement can then be re-started for the new grid section 8 as per step S6.III. The steps S6.IV to S6.VI are then repeated. The steps S6.III to S6.VI can be repeated a number of times in a loop until the vehicle 4 completes its journey and the energy measurement carried out according to step S6.III is terminated. In this case the electrified vehicle 4 lowers its pantograph 9 in step S6.VII and disconnects from the overhead line 22. In step S6.VIII the measured energy consumption values are stored by the processing unit 15. Finally, in step S6.IX, the pantograph-down event is stored in the processing unit 15. This terminates the entire process.

FIG. 7 shows a flow chart which illustrates the individual steps of a method according to an alternative exemplary embodiment of the invention. In the alternative implementation, instead of using a location identifier 10 on the overhead line 22 for detecting a crossover from one grid section 8 to another, a positioning unit 16 on the electrified vehicle 4 is used, wherein the method according to this alternative exemplary embodiment consists of the following steps for measuring and storing the data in the vehicle 4: In step S7.I an electrified vehicle 4 raises its pantograph 9 and makes contact with the overhead line 22. In step S7.II the pantograph-up event is stored by the processing unit 15. In step S7.III the geocoordinates, i.e. the position of the vehicle 4 determined by the positioning unit 16 are stored by the processing unit 15. In step S7.IV, the energy drawn or fed back by the electrified vehicle 4 is measured during movement or operation of the electrified vehicle 4. In step S7.V, geocoordinates 16 are requested from the positioning unit at cyclical intervals, e.g. every minute. In steps S7.VI and S7.VII, the energy consumption values for this cycle are stored together with the geocoordinates by the processing unit 15. The energy consumption measurement can then be restarted for the new cycle time according to step S7.IV. Steps S7.V to S7.VII are then repeated. Steps S7.IV to S7.VII can then be repeated a number of times in a loop until the vehicle 4 completes its journey and energy measurement is terminated according to step S7.IV. In this case the electrified vehicle 4 lowers its pantograph 9 at step S7.VIII and disconnects from the overhead line 22. In step S7.IX the measured energy consumption values are stored by the processing unit 15. In step S7.X the geocoordinates determined by the positioning unit for the pantograph-down event are stored by the processing unit 15. Finally, in step S7.XI the pantograph-down event is stored in the processing unit 15. This completes the entire process.

The data records generated and stored by the processing unit 15 according to methods in FIG. 5, 6 or 7 are transmitted cyclically, e.g. daily, monthly or weekly, to a data distribution unit 19 which has a processing unit 20. This processing unit 20 processes the data and forwards it according to the method explained in connection with FIG. 8.

FIG. 8 schematically illustrates data transmission between the mobile energy consumer 4 and the individual units of the power grid 5. The electrified vehicle 4 or rather the energy measuring apparatus 13 installed in that vehicle is assigned to an electricity supplier 23 as shown. In addition, an assignment to a substation 11 or a grid section 8 and an overhead line infrastructure operator 7 or grid section operator 8 is performed by the processing unit 15 according to the data acquired in respect of the location identifiers 10.

The data record generated by the processing unit 15 on the electrified vehicle 4 is transmitted to a data distribution unit 19, this taking place, for example, by means of a known radio standard (mobile communication, WLAN, sensor networks (see S8.I in FIG. 8).

The data record generated according to above methods can have the content shown in Table 1:

TABLE 1
Electric vehicle 1, meter number of energy
measuring apparatus, data record

| Point in time | Pantograph-up event | |
|---|---|---|
| Time period | Energy value | x kWh consumption, |
| | | y kWh feedback |
| Point in time | Location identifier | c |
| Time period | Energy value | x kWh consumption, |
| | | y kWh feedback |
| Point in time | Location identifier | b |
| Time period | Energy value | x kWh consumption, |
| | | y kWh feedback |
| Point in time | Pantograph-down event | |

The data distribution unit 19 for its part assigns the energy consumption values to an electricity supplier 23 on the basis of the license plate of the electrified vehicle 4 or the meter number of the energy measuring apparatus 13 of the electrified vehicle 4 (see S8.II in FIG. 8).

The data distribution unit 19 generates a billing data record for the identified electricity supplier 23 or rather the electricity supplier's administration system 24 (in the drawing e.g. the administration system 24.1) and transmits the energy consumption values, broken down according to the energy consumed in the respective grid section 8 or according to the consumed energy assigned to the respective substation 11 (see S8.III in FIG. 8). The data record generated can look as shown in Table 2:

TABLE 2
Data record to electricity supplier

| | | | |
|---|---|---|---|
| Delivery station | Time | x kWh consumption | y kWh feedback |
| substation 3 | period | | |
| Delivery station | Time | x kWh consumption | y kWh feedback |
| substation 2 | period | | |
| Delivery station | Time | x kWh consumption | y kWh feedback |
| substation 1 | period | | |

The data distribution unit 19 assigns the energy consumption values to the overhead line infrastructure operators 7 (e.g. overhead line infrastructure operators 7A and 7B) on the basis of the location identifiers 10 of the overhead line infrastructure sections 8 for each substation 11. (see S8.IV in FIG. 8)

The processing unit 15 optionally generates an energy consumption data record for the identified overhead line infrastructure operators 7A, 7B and transmits the energy consumption values, broken down by energy transmission via the respective substation 11. (1, 2, 3) or broken down by energy consumed in the respective grid section 8, to the corresponding administration system 25A, 25B of the overhead line infrastructure operator 7A or 7B as the case may be (see S8.V FIG. 8). The data records generated can look as shown in Table 3:

TABLE 3
Data record to overhead line infrastructure
operator A for electr. vehicle/meter number

| | | | |
|---|---|---|---|
| Delivery station | Time | x kWh consumption | y kWh feedback |
| substation 1 | period | | |

Data record to overhead line infrastructure
operator B for electr. vehicle/meter number

| | | | |
|---|---|---|---|
| Delivery station | Time | x kWh consumption | y kWh feedback |
| substation 2 | period | | |
| Delivery station | Time | x kWh consumption | y kWh feedback |
| substation 3 | period | | |

By distributing the data records, the following billing mechanisms can be implemented: The overhead line infrastructure operators 7 receive appropriate grid fees from the electricity suppliers 23. The grid fees are determined by the electricity suppliers 23 on the basis of energy delivery via the various substations 11 or on the basis of the energy consumption of the respective mobile energy consumers 4 that is assigned to the respective grid sections 8. Optionally, the overhead line infrastructure operators 7 can additionally keep a check on the calculation of the grid fees, as the consumption data is likewise available to them.

The overhead line infrastructure operators 7 can optionally levy usage charges on the owner of the electrified vehicle 4 on the basis of the data records over the overhead line sections 8 used.

According to the embodiments described, the invention provides an elegant and simple solution to the problem of billing the energy consumption of nonstationary loads 4 in a power grid 5 having a plurality of grid sections 8 operated by different grid operators 7.

In addition, the existing system for energy billing in the liberalized electricity market can continue to be used without redefinitions and modifications. The system is inventively re-used, wherein it is significantly further developed.

Moreover, different commercial processes are possible for the overhead line infrastructure operators on the basis of the subject matter of the invention. On the one hand it allows refinancing of the overhead line via grid fees levied and paid over by the electricity suppliers. On the other hand, refinancing of the overhead line can be implemented via user charges for which the owners of the electrified vehicles are billed directly.

In conclusion, it is once again pointed out that the methods and devices described in detail above are merely examples which can be modified by persons skilled in the art without departing from the scope of the invention. In addition, the use of the indefinite article “a” or “an” does not exclude the possibility of the features in question also being present more than once. Likewise, the terms “unit” and “module” do not exclude the possibility of the components in question consisting of a plurality of interacting sub-components which may possibly also be spatially distributed.

1-17. (canceled)

18. A method for the energy billing of mobile energy consumers in an electrical power grid, the electrical power grid having a plurality of grid section operators with territorially separate grid sections, the method comprising:
detecting a crossover of a mobile energy consumer from one grid section to another grid section; and
assigning the energy consumed by the mobile energy consumer between two crossovers in a grid section to the detected grid section.

19. The method according to claim 18, wherein the energy consumed in the detected grid section and assigned to the detected grid section is assigned to the grid section operator operating the detected grid section.

20. The method according to claim 18, wherein the power grid is a track-bound grid and/or an electrical power grid and the mobile energy consumer is an electrified vehicle having a current collector.

21. The method according to claim 18, which comprises, upon detecting the crossover of the mobile energy consumer from one grid section to another grid section, determining a position of the mobile energy consumer by a position determining method using a position determination system and assigning the ascertained position of the mobile energy consumer to a grid section and/or wherein the step of detecting the crossover of the mobile energy consumer from one grid section to another grid section comprises reading a location identifier, wherein the location identifier indicates the crossover of the mobile energy consumer from one grid section to another grid section.

22. The method according to claim 21, which comprises repeating the step of determining the position of the mobile energy consumer after a predetermined time.

23. The method according to claim 18, which comprises beginning a measurement of the energy consumption of the mobile energy consumer when the mobile energy consumer establishes electrical contact with the power grid and terminating the measurement when the mobile energy consumer disconnects from the power grid.

24. The method according to claim 21, which comprises reading the location identifier by a reader unit when the mobile energy consumer passes the location identifier.

25. The method according to claim 18, which comprises storing measured energy consumption values in a processing unit after a crossover of the mobile energy consumer from one grid section to another and/or after disconnection from the power grid by the mobile energy consumer, and/or storing the information determined in connection with the crossover of the mobile energy consumer from one grid section to another in the processing unit.

26. The method according to claim 25, which comprises storing by the processing unit an event of the mobile energy consumer connecting to the power grid and/or an event of the mobile energy consumer disconnecting from the power grid.

27. In combination with an electrical power grid having a plurality of grid section operators to which territorially separated grid sections are assigned and having an energy measuring unit which determines an energy consumed by a mobile energy consumer, a device of a mobile energy consumer for energy billing in the electrical power grid, the device comprising:
a detection unit for detecting a crossover of the mobile energy consumer from one grid section to another grid section; and
a processing unit for acquiring and storing the data determined by the energy measuring unit and by the detection unit.

28. The device according to claim 27, wherein said detection unit has a positioning unit for determining a position of the mobile energy consumer.

29. The device according to claim 27, wherein said processing unit is configured to assign the energy measured by said energy measuring unit that is consumed between two crossovers by the mobile energy consumer in a grid section to the grid operator of the grid section and/or to generate a data record which assigns the energy measured by the energy measuring unit that is consumed by the mobile energy consumer between two crossovers in a grid section to the grid section.

30. The device according to claim 27, which further comprises a transmission unit for transmitting data determined in the device to a data distribution unit.

31. A data distribution unit, configured to receive data from the device according to claim 27 and to assign the data received from the device in respect of a grid section to an associated grid section operator.

32. A mobile energy consumer, comprising:
a device according to claim 27; and
a transmission unit for transmitting data determined in said device to a data distribution unit.

33. The mobile energy consumer according to claim 32, configured as a truck, having an electric drive, and a device for connecting to an electrical supply line of a power grid.

34. A grid section for an electrical power grid, comprising:
at least one location identifier marking a boundary between one grid section and another grid section between two adjacent grid sections of the electrical power grid;
at least one administration unit configured to receive data in respect of energy consumed by a mobile energy consumer in a particular grid section and to determine and bill grid fees and/or usage charges on a basis of the data.
